(19) United States
(12) Patent Application Publication
(10) Pub. No.: US 2005/0134727 A1
(43) Pub. Date: Jun. 23, 2005

(54) Camera

(75) Inventors: Tougo Teramoto, Wakayama-shi (JP); Hisanori Itoh, Osaka (JP); Kazuhiko Kojima, Osaka (JP); Yoshito Konishi, Osaka (JP); Atsushi Yamanishi, Osaka (JP); Satoshi Yokota, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/011,260

(22) Filed: Dec. 14, 2004

(30) Foreign Application Priority Data
Dec. 18, 2003 (JP) 2003-421256

(51) Int. Cl. H04N 5/225

(52) U.S. Cl. 348/375

(57) ABSTRACT

A camera having a box-form cover member slidable on a camera body between a closed position and an opened position. The camera further has a heat releasing member that releases heat generated within the camera body, into a space formed between the camera body and the cover member.

### CROSS-REFERENCE TO RELATED APPLICATION

This application is based on Japanese Patent Application No. 2003-421256 filed in Japan on Dec. 18, 2003, the content of which is hereby incorporated by reference.

### BACKGROUND OF THE INVENTION

1. Field of the Invention

The present invention relates to a small-size camera, particularly, to a capsule-type camera that has a box-form cover member being sidable on the camera body.

2. Description of the Related Art

A camera has previously been proposed that has a box-form cover member being slidable on the camera body between a closed position and an opened position and changes whether shooting is enabled or not according to the position of the cover member. This type of camera is generally called a capsule camera or a capsule-type camera. In the capsule-type camera, since the cover member is normally closed for storage or carrying, the taking lens is protected by the cover member. At the time of shooting, by the user opening the cover member of the capsule-type camera, the taking lens is exposed so that shooting is enabled.

On the other hand, a digital-type camera (a digital camera or an electronic camera) uses a CCD for image sensing, an LCD for image display, a CPU or an ASIC for image processing and control, and other multiplicity of electronic parts. Since these electronic parts generate heat due to current, a structure for releasing the generated heat is necessary. In the digital camera, since the number of pixels has increased because of improvements in image quality and the processing performance has dramatically improved, the amount of heat generation tends to increase. Further, in the digital camera, since the size and weight have been further reduced and plastic is frequently used instead of metal for the exterior of the camera body, it has become difficult to release the heat generated inside the camera body, at the exterior part.

Therefore, various heat releasing structures have been proposed such as the provision of a heat releasing plate on a part of the camera body that is opposite to the rear surface of the LCD and the provision of heat releasing holes at the bottom of the housing of a pop-up strobe flash).

However, for cameras, it is necessary to adopt various elements such as portability, design and fashion as well as the essential performance of the camera, and for the heat releasing structure, it is also necessary to be adaptable to these elements. However, previously proposed heat releasing structures do not sufficiently adapt to elements such as portability, design and fashion.

### SUMMARY OF THE INVENTION

A principal object of the present invention is to provide a small-size camera that sufficiently adapts to portability, design and fashion and capable of releasing the heat generated inside the camera body.

Another object of the present invention is to provide a capsule-type camera that has a box-form cover member being sidable on the camera body and is capable of releasing the heat generated inside the camera body.

The above-mentioned object of the present invention is attained by providing a camera comprising: a box-form cover member that is sidable on a camera body between a closed position and an opened position; and a heat releasing member that releases heat generated within the camera body into a space formed between the camera body and the cover member.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a front view of a digital camera according to a first embodiment of the present invention;

FIG. 2 is a front view of the digital camera according to the first embodiment of the present invention when a cover member is in opened state;

FIG. 3 is a front cross-sectional view showing part of the internal structure of the digital camera according to the first embodiment of the present invention;

FIG. 4 is a front cross-sectional view showing part of the internal structure of the digital camera according to the first embodiment of the present invention when the cover member is in opened state;

FIG. 5 is a perspective view of a heat releasing plate in the digital camera according to the first embodiment of the present invention;

FIG. 6 is a front view of a digital camera according to a second embodiment of the present invention;

FIG. 7 is a front view of the digital camera according to the second embodiment of the present invention when a cover member is in opened state;

FIG. 8 is a perspective view of the digital camera according to the second embodiment of the present invention when the cover member is in opened state;

FIG. 9 is a front cross-sectional view showing part of the internal structure of the digital camera according to the second embodiment of the present invention;

FIG. 10 is a front view of a digital camera according to a third embodiment of the present invention;

FIG. 11 is a front view of the digital camera according to the third embodiment of the present invention when a cover member is in opened state;

FIG. 12 is a front cross-sectional view showing part of the internal structure of the digital camera according to the third embodiment of the present invention;

FIG. 13 is a front cross-sectional view showing part of the internal structure of the digital camera according to the third embodiment of the present invention when the cover member is in opened state; and

FIG. 14 is an upper cross-sectional view showing part of the internal structure of the digital camera according to the third embodiment of the present invention.

### DESCRIPTION OF THE PREFERRED EMBODIMENTS

Embodiments of the camera according to the present invention will be described with reference to the attached drawings.

[First Embodiment]

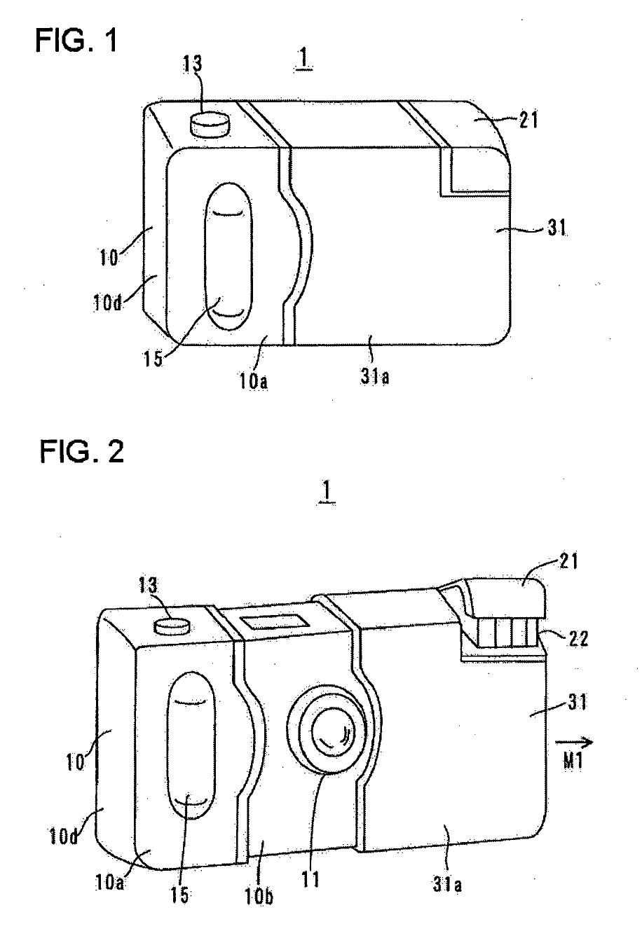

A digital camera 1 according to a first embodiment of the present invention will be described with reference to FIGS. 1 to 5.

In FIGS. 1 and 2, the digital camera 1 has a camera body 10 which is an exterior made of a metal material such as an aluminum alloy or a titanium alloy, or a plastic material. A cover member 31 is provided so as to be sidable on the camera body 10 between a closed position shown in FIG. 1 and an opened position shown in FIG. 2.

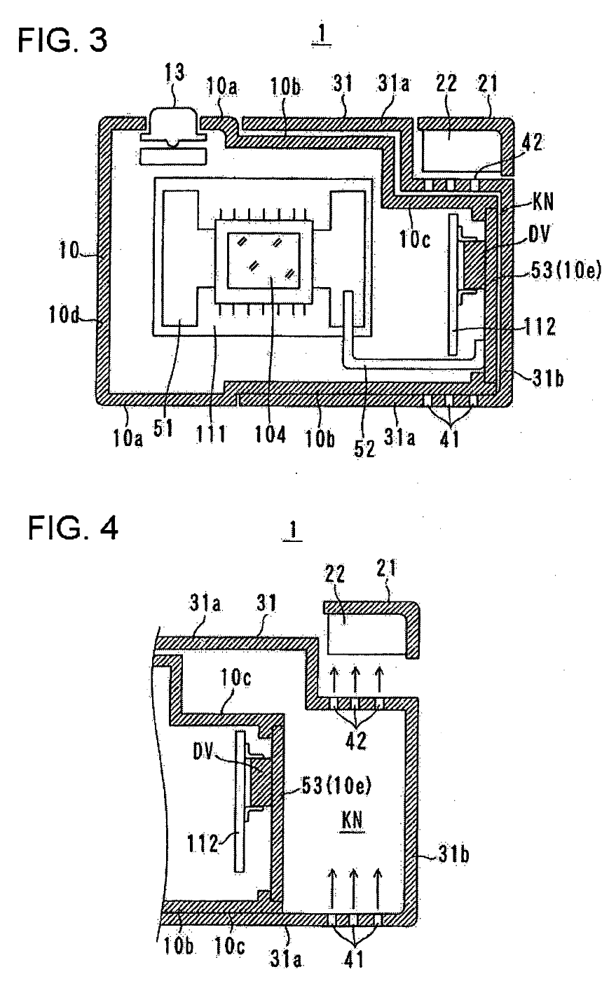

The camera body 10 comprises an external box part 10a, an intermediate box part 10b, an internal box part 10c (FIGS. 3 and 4), a left side surface part 10d and a right side surface part 10e (FIG. 3). Of the tubular part formed by, with the surface where a taking lens 11 is provided as the front, a front plate part, a top plate part, a bottom plate part and a rear plate part being continuous with one another, the external box part 10a is the part that is not covered with the cover member 31. The intermediate box part 10b is covered and exposed by the sliding of the cover member 31. The internal box part 10c is narrowed by the provision of a step part in correspondence with a flash cover 21. The left side surface part 10d is the side surface on the left side, and the right side surface part 10e is the side surface on the right side.

The cover member 31 has a box form and is made of a metal material or a plastic material similar to the material of the camera body 10. In the present embodiment, the cover member 31 has a tube form having a bottom and having its one end opened. The cover member 31 comprises: a tubular part 31a formed by the front plate part, the top plate part, the bottom plate part and the rear plate part being continuous with one another; and a right side surface part 31b which is the side surface on the right side (FIGS. 3 and 4).

When the cover member 31 is in the closed position as shown in FIG. 1, the digital camera 1 is overall compact and has a shape suitable for carrying, and the cover member 31 protects the lens 11 so that the lens 11 is prevented from being scratched or made dirty. By setting the cover member 31 in the opened position by sliding it in the direction of the arrow M1 as shown in FIG. 2, the taking lens 11 appears substantially in the center of the front surface so that shooting is enabled, and the length of the digital camera 1 increases in the horizontal direction so that it is facilitated to firmly hold the entire camera with both hands. The cover member 31 is sometimes called a cover or a lens barrier.

On the surface of the external box part 10a of the camera body 10, members such as a release button 13 and a grip 15 are provided. On the cover member 31, the flash cover 21 is provided so as to form part of the cover member 31. When flash shooting is performed, the flash cover 21 pops up as shown in FIG. 2 so that a light emitting panel (flash unit) 22 appears.

As shown in FIGS. 3 and 4, an image sensor 104 such as a CCD, substrates 111 and 112, an electronic circuit element DV, heat releasing plates 51 and 53, a heat pipe 52 are provided in the camera body 10. Further, a display device, a memory, a storage medium, an interface, a battery, and other electronic parts, optical parts and mechanical parts (They are not shown in the figures.) are provided in the camera body 10.

The image sensor 104 captures the subject image formed by the taking lens 11 and converts it into an electric signal. The image sensor 104 is fixed to the substrate 111 by means of soldering with the metal heat releasing plate 51 in between.

The electronic circuit element DV soldered to the substrate 112 is provided in the internal box part 10c of the camera body 10. The electronic circuit element DV is, for example, a driver element for the motor or the actuator for mechanical driving. The heat releasing plate 53 is provided in the position of the right side surface part 10e of the camera body 10.

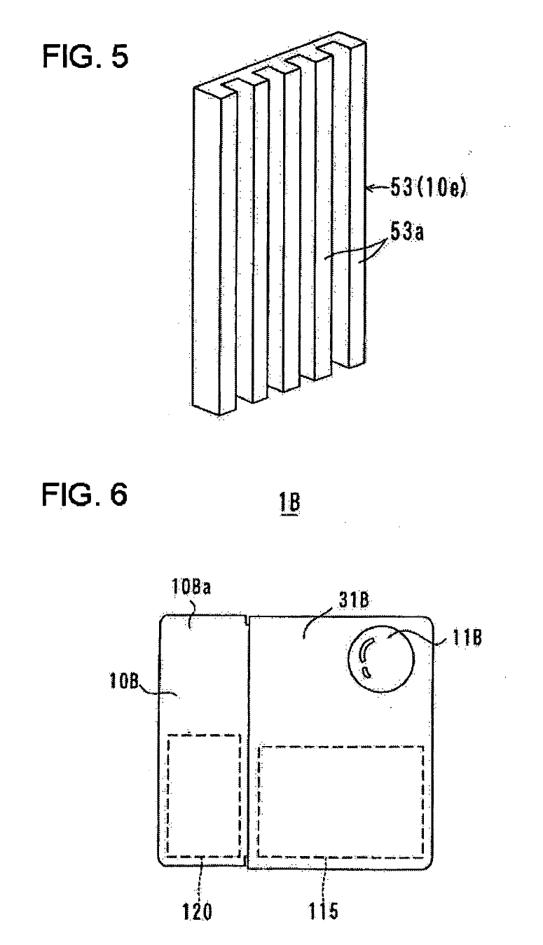

The heat releasing plate 53 has a plate form and is made of a metal such as an aluminum alloy, a copper alloy or iron. The heat releasing plate 53 can more effectively release heat by being provided with a heatsink structure having a multiplicity of fins 53a as shown in FIG. 5. To further enhance the heat releasing effect, a surface treatment to blacken the surface of the heat releasing plate 53 may be performed.

The heat releasing plate 53 constitutes the right side surface part 10e of the camera body 10. When the heat releasing plate 53 has the fins 53a like FIG. 5, the fins 53a are attached to an end of the internal box part 10c so as to be exposed to the outside of the camera body 10, that is, a space KN (FIGS. 3 and 4) formed between the right side surface part 10e of the camera body 10 and the right side surface part 31b of the cover member 31. The heat releasing plate 53 and the electronic circuit element DV are in contact with each other through a non-illustrated known sheet that is excellent in heat conductivity, so that the heat generated at the electronic circuit element DV is sufficiently transmitted to the heat releasing plate 53. As such a sheet, tape or rubber that is excellent in heat conductivity may be used. Moreover, the heat releasing plate 51 and the heat releasing plate 53 are thermally coupled together by the known heat pipe 52, so that the heat of the heat releasing plate 51 is sufficiently transmitted to the heat releasing plate 53 through the heat pipe 52.

As shown in FIG. 3, the tubular part 31a of the cover member 31 has a plurality of holes 41 and 42 at its bottom plate part and top plate part. As well shown in FIG. 4, the holes 41 and 42 are provided so that air circulates between the space KN and the outside when the cover member 31 is set in the opened position, thereby the heated air in the space KN is released to the outside and cool air in the outside flows into the space KN. The holes 42 are provided below the light emitting panel 22, and when the light emitting panel 22 pops up, the space above the holes 42 is enlarged to facilitate the air circulation.

In the position of the tubular part 31a where the holes 41 and 42 are provided, a filter may be provided that is made of an appropriate woven or nonwoven fabric, for example, a material that is excellent in breathability and does not allow water drops to pass therethrough such as Gore-Tex (trademark).

The workings of the heat releasing structure of the digital camera 1 according to the first embodiment will be described.

To use the digital camera 1, the cover member 31 is slid to the opened position shown in FIG. 2. In response to the cover member slide to the opened position, the power of the digital camera 1 is turned on. Shooting can be performed by depressing the release button 13 under this condition. The image captured by the image sensor 104 is converted to an electric signal, processed by the CPU or the ASIC, and displayed by the display device. When the release button 13 is depressed, the image is recorded into a memory or a recording medium. When necessary, the image recorded in the memory or the recording medium is transferred to an external computer or the like through a non-illustrated interface.

When the digital camera 1 is in use, the heat generated from the image sensor 104 is transmitted from the heat releasing plate 51 to the heat releasing plate 53 through the heat pipe 52. The heat generated from the electronic circuit element DV is directly transmitted to the heat releasing plate 53 by way of a conductive sheet or the like. The heat releasing plate 53 faces the space KN, and effectively releases heat into the space KN by the fins 53a. Since the cover member 31 is in the opened position when the digital camera 1 is in use, the space KN is largest as shown in FIG. 4. In the space KN,. air has its high-. heat part cooled by convection, and the heat in the space KN is released to the outside through the tubular part 31a and the right side surface part 31b of the cover member 31. Moreover, the air in the space KN is discharged to the outside through the holes 41 and heat release is also performed. Furthermore, at the time of flash shooting when heat is generated by light emission, since the space above the holes 42 is enlarged, the air in the space KN is further effectively discharged. Thus, the heat generated inside the digital camera 1 is effectively released, so that the temperature rise of the digital camera 1 is prevented.

There is no possibility that the user's hand or the like directly touches the inside of the space KN because the inside is covered with the cover member 31 or the like. Moreover, the inside of the space KN cannot be seen from the outside. Therefore, with respect to the heat releasing plate 53 or the structure for attaching the heat releasing plate 53, the shape and the color, design can be performed in consideration of only functions without any consideration given to the appearance, so that a design with the highest heat releasing effect can be adopted. For example, even when the heat releasing plate 53 having the fins 53a as shown in FIG. 5 is adopted, since the fins 53a cannot be seen from the outside, the most efficient heat releasing structure can be adopted without regard to the appearance.

Consequently, according to the digital camera 1 of the present embodiment, since the heat releasing performance can be further improved, the generation of noise due to a temperature rise of the electronic circuit element can be reduced, so that the damage of circuits and devices due to overheating can be easily prevented. Moreover, since the occurrence of a local high temperature can be suppressed by reducing the overall temperature of the digital camera 1, the discomfort caused to the user by the temperature can be reduced or eliminated.

In the above-described embodiment, the CPU or the ASIC, the CCD, the driver element such as the motor or the actuator (switching element such as a transistor), and a switching element for charging the motor, the actuator, the battery and the light emitting panel are large in heat generation amount. Therefore, a necessary one is selected from among these electronic circuit elements, and the selected one is brought into direct contact with the heat releasing plate 53 or is thermally coupled to the heat releasing plate 53 through the heat pipe 52 or the like. In particular, the CPU or the ASIC may be disposed as the electronic circuit element DV so as to be in direct contact with the heat releasing plate 53. To improve the adhesion between the electronic circuit element DV and the heat releasing plate 53, an appropriate surface treatment may be performed.

Moreover, holes for the circulation of air between the inside of the camera body 10 and the space KN may be provided in the heat releasing plate 53. Similar holes may be provided in the unexposed part of the camera body 10.

[Second Embodiment]

A second embodiment of the present invention will be described with reference to FIGS. 6 to 9.

Since the basic function and structure, as a camera, of a digital camera 1B are similar to those of the digital camera 1 of the above-described first embodiment, parts having the same functions are denoted by the same reference numerals or the same reference numerals with the suffix “B”, and the descriptions thereof are simplified or omitted.

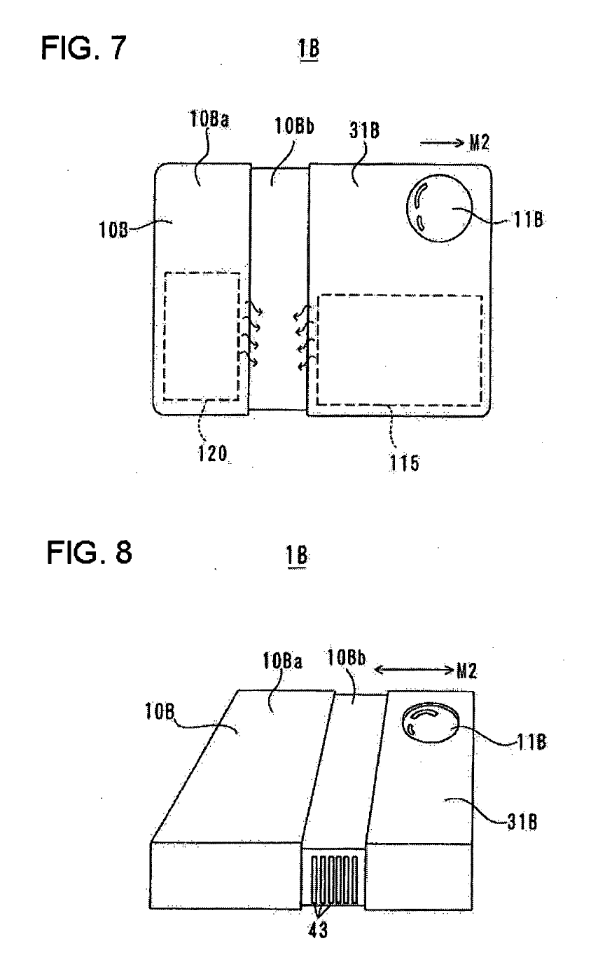

In FIGS. 6 to 9, the digital camera 1B has a camera body 10B which is an exterior. A cover member 31B is provided so as to be sidable on the camera body 10B between a closed position shown in FIG. 6 and an opened position shown in FIG. 7.

A shooting mode is changed according to the position of the cover member 31B. That is, when the cover member 31B is in the closed position (FIG. 6), a mode to permit shooting of still images (still image shooting mode) is set. When the cover member 31B is in the opened position (FIG. 7), a mode to permit shooting of motion pictures (motion picture shooting mode) is set. Moreover, when the cover member 31B is set in the opened position, the space KN is formed inside an intermediate box part 10Bb of the camera body 10B. In the bottom plate part of the intermediate box part 10Bb, holes 43 and 44 are provided for circulating air between the space KN and the outside to promote heat release (FIG. 8).

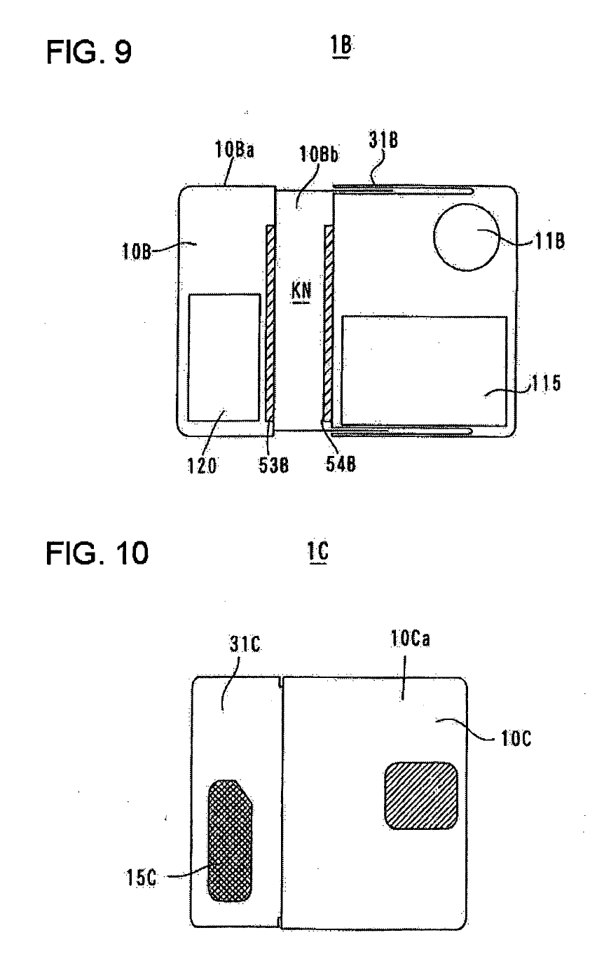

As shown in FIG. 9, a battery 120 is placed in an external box part 10Ba of the camera body 10B. A heat releasing plate 53B is provided on the side surface of the external box part 10Ba that faces the space KN. The heat generated from the battery 120 is released into the space KN by the heat releasing plate 53B.

An electronic circuit block 115 comprising various electronic circuit elements and circuits is provided in the cover member 31B. A heat releasing plate 54B is provided on the side surface of the cover member 31B that faces the space KN. The heat generated from the electronic circuit block 115 and the like is released into the space KN by the heat releasing plate 54B.

When the cover member 31B is set in the opened position and the moving image shooting mode is set with the non-illustrated power switch being on, the space KN is enlarged, so that heat release at the time of moving image shooting is effectively performed. Since the heat generation amount is larger at the time of moving image shooting than at the time of still image shooting, by effectively releasing heat at the time of moving image shooting, the design of the overall structure and configuration of the digital camera 1B is facilitated, so that the overall size can be reduced. Moreover, since the cover member 31B is in the opened position at the time of moving image shooting and the size of the digital camera 1 is increased, the user can easily grip the camera, so that moving image shooting for a long time can be performed stably.

Holes for air circulation may be provided in the heat releasing plate 53B or the side surface where the heat releasing plate 53B is provided and in the heat releasing plate 54B or the side surface where the heat releasing plate 54B is provided.

[Third embodiment]

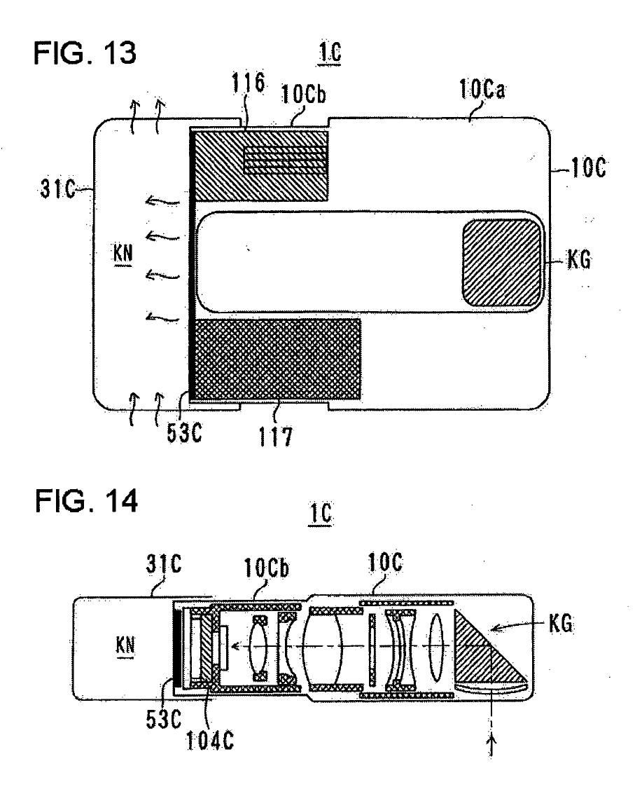

A third embodiment of the present invention will be described with reference to FIGS. 10 to 14.

Since the basic function and structure, as a camera, of a digital camera 1C are similar to those of the digital camera 1 of the above-described first embodiment, parts having the same functions are denoted by the same reference numerals or the same reference numerals with the suffix “C”, and the descriptions thereof are simplified or omitted.

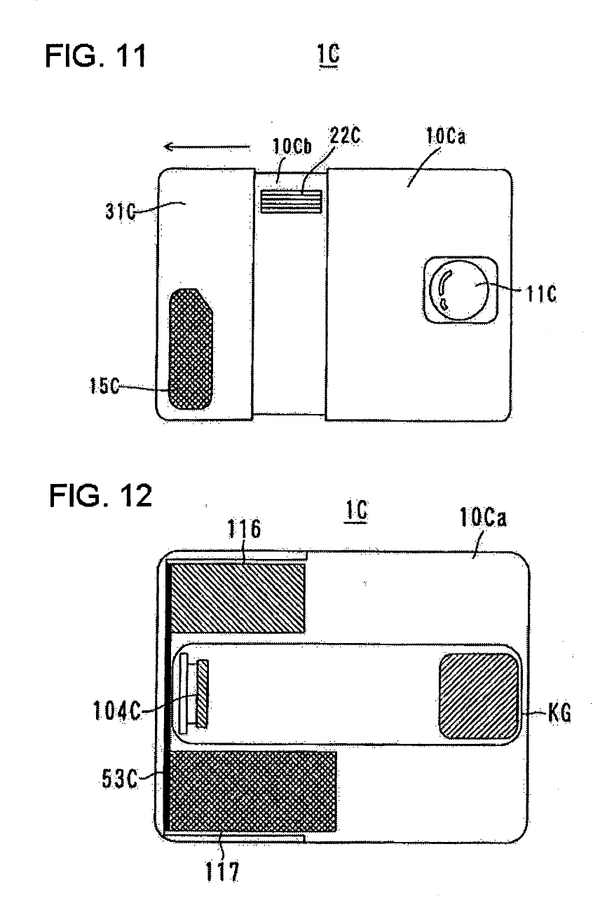

In FIGS. 10 to 14, the digital camera 1C has a camera body 10C which is an exterior. A cover member 31C is provided so as to be slidable on the camera body 10C between a closed position shown in FIG. 10 and an opened position shown in FIG. 11.

When the cover member 31C is set in the opened position as shown in FIG. 11, the power of the digital camera 1C is turned on and the protective lid for the lens 11 is opened, so that shooting is enabled. At this time, a light emitting panel 22C is exposed so that flash is also enabled. Moreover, when the cover member 31C is set in the opened position, the space KN is formed in an intermediate box part 10Cb of the camera body 10C. Non-illustrated holes for circulating air between the space KN and the outside to promote heat release are provided at the top and bottom of the cover member 31C.

A charging circuit 116 for the light emitting panel 22C, an image processing circuit 117, other circuits, an image sensor 104C and a bending optical system KG and the like are provided in the camera body 10C. A heat releasing plate 53C (FIG. 12) is provided on the side surface of the intermediate box part 10Cb of the camera body 11C that faces the space KN. The heat generated from the charging circuit 116, the image processing circuit 117, the image sensor 104C and the like is released into the space KN by the heat releasing plate 53C. The heat in the space KN is released to the outside through the cover member 31C. Moreover, heat release is also performed by circulating air through the holes provided in the cover members 31C.

As described above, the heat from the electronic circuit element and parts is effectively released also in the digital camera 1C of the third embodiment.

In the first to third embodiments, the structure, configuration, shape, dimensions, function, the number of parts and processing contents of the digital cameras 1, 1B and 1C may take various forms other than the above-described ones. The camera includes video cameras and film cameras as well as the above-mentioned digital cameras.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

1. A camera comprising:
a box-form cover member that is slidable on a camera body between a closed position and an opened position; and
a heat releasing member that releases heat generated within the camera body, into a heat releasing space formed between the camera body and the cover member.

2. A camera as claimed in claim 1 wherein said heat releasing member releases heat into the heat releasing space when said box-form cover member is in the opened position.

3. A camera as claimed in claim 1 wherein said heat releasing member faces the heat releasing space, and heat generated by at least one part within the camera body is transmitted to the heat releasing member by heat conduction or a heat transmitting member.

4. A camera as claimed in claim 3 wherein said heat transmitting member is a heat pipe provided between the heat generating part and the heat releasing member.

5. A camera as claimed in claim 3 wherein said part includes a CPU, an ASIC, a CCD, a motor, an actuator, a battery or a light emitting panel.

6. A camera as claimed in claim 1 wherein the box-form cover member is provided with a plurality of holes so that air circulates between outside of the cover member and the heat releasing space.

7. A camera as claimed in claim 1 wherein the heat releasing member is provided with a plurality of holes so that air circulates between inside of the camera body and the heat releasing space.

8. A camera as claimed in claim 1 further comprising:
a flash unit provided above the heat releasing space and having a flash cover that pops up.

9. A camera as claimed in claim 1 wherein a power of said camera is turned on when the cover member is slid to the opened position.

10. A camera as claimed in claim 1 wherein said camera is set to a still image shooting mode when the cover member is in the closed position, and is set to a motion picture shooting mode when the cover member is in the opened position.

11. A camera as claimed in claim 1 wherein the heat releasing member has a plurality of fins.

12. A camera comprising:
an image taking lens which directs a subject image onto an imaging surface;
a cover member which covers a camera body and is movable between an opened position and a closed position, the image taking lens is protected by the said cover member positioned in said closed position when the camera is not operated, and the image taking lens is exposed from the cover member when the camera is in operation; and
a heat releasing member that releases heat generated within the camera body into a heat releasing space formed between the camera body and the cover member when the cover member is in the opened position.

13. A camera as claimed in claim 12 wherein said heat releasing member faces the heat releasing space, and heat generated by at least one part within the camera body is transmitted to the heat releasing member by heat conduction or a heat transmitting member.

14. A camera as claimed in claim 13 wherein said part includes a CPU, an ASIC, a CCD, a motor, an actuator, a battery or a light emitting panel.

15. A camera comprising:
a cover member which covers a camera body and is movable between an opened position and a closed position, the camera capturing an image of a subject in a first mode when the cover member is in said opened position and capturing the image of the subject in a second mode when the cover member is in the closed position; and
a heat releasing member that releases heat generated within the camera body into a heat releasing space formed between the camera body and the cover member when the cover member is in the opened position.

16. A camera as claimed in claim 15 wherein said first mode is a still image shooting mode, and the second mode is a motion picture shooting mode.
